(19) United States
(12) Patent Application Publication
(10) Pub. No.: US 2018/0131800 A1
(43) Pub. Date: May 10, 2018

(54) CONTROL APPARATUS, CONTROL SYSTEM, AND METHOD FOR CONTROLLING CONTROL APPARATUS

(71) Applicant: Olympus Corporation, Tokyo (JP)

(72) Inventors: Koichi Shintani, Hachioji-shi (JP); Yoshihisa OGATA, Hachioji-shi (JP)

(21) Appl. No.: 15/803,693

(22) Filed: Nov. 3, 2017

(30) Foreign Application Priority Data
Nov. 7, 2016 (JP) 2016-217188

(51) Int. Cl. H04M 1/725; H04N 5/232; H04W 4/00

(52) U.S. Cl. CPC H04M 1/7253; H04W 4/008; H04N 5/232

(57) ABSTRACT

According to an aspect of the invention, a control apparatus includes a built-in function execution unit, a communication unit, and at least one control circuit. The built-in function execution unit is configured to execute a built-in function. The communication unit communicates with an external device configured to execute an external function identical to the built-in function. The at least one control circuit obtains performances of the built-in function and the external function, determines which performance of the built-in function performance and the external function performance is higher, and recommends use of the external device, if the external function performance is higher than the built-in function performance.

### CROSS-REFERENCE TO RELATED APPLICATIONS

This application is based upon and claiming the benefit of priority from prior Japanese Patent Application No. 2016-217188, filed Nov. 7, 2016, the entire contents of which are incorporated herein by reference.

### BACKGROUND OF THE INVENTION

### 1. Field of the Invention

The present invention relates to a control apparatus, a control system, and a method for controlling a control apparatus.

### 2. Description of the Related Art

Information communication technologies (ICT) have recently been utilized in various fields. Attention has been given to an electronic device having a communication function and an aspect of being connected to a network, such as the Internet, or to a system including such an electronic device, in other words, a network device, such as an Internet of Things (IoT) device. For example, Jpn. Pat. Appln. KOKAI Publication No. 2009-267666 discloses a technology of determining whether or not a wireless communication device that a user wants to use is on the user's car.

### BRIEF SUMMARY OF THE INVENTION

According to an aspect of the invention, a control apparatus includes a built-in function execution unit, a communication unit, and at least one control circuit. The built-in function execution unit is configured to execute a predetermined function. The communication unit communicates with an external device including an external function execution unit configured to execute a function identical to the function of the built-in function execution unit. The at least one control circuit obtains, as a built-in function performance, a performance of the built-in function execution unit, obtains, as an external function performance, a performance of the external function execution unit via the communication, determines which performance of the built-in function performance and the external function performance is higher for a comparable predetermined function, refers to a result of the determination according to a situation of execution of a function when the built-in function execution unit executes the function, and recommends use of the external device, when the external function performance is higher than the built-in function performance.

According to an aspect of the invention, a control system includes the control apparatus and the external device.

According to an aspect of the invention, a control method executes a predetermined function, communicates with an external device including an external function execution unit configured to execute a function identical to the function, obtains, as a built-in function performance, a performance of the function, obtains, as an external function performance, a performance of the external function execution unit via the communication, determines which performance of the built-in function performance and the external function performance is higher for a comparable predetermined function, refers to a result of the determination according to a situation where the function is executed during execution of the function, and recommends use of the external device when the external function performance is higher than the built-in function performance.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an outline of the configuration example of a control system according to a first embodiment.

FIG. 2 is a schematic diagram showing an example of an outline of an exterior appearance of an IC recorder according to the first embodiment.

FIG. 3 is a diagram showing an example of the configuration of a performance-specific external device DB according to the first embodiment.

FIG. 4 is a flowchart showing an example of smartphone control processing according to the first embodiment.

FIG. 5A is a schematic diagram showing a situation when a video mode of a smartphone according to the first embodiment is selected.

FIG. 5B is a schematic diagram showing a situation where the IC recorder is recommended by the smartphone according to the first embodiment.

FIG. 5C is a schematic diagram showing an example of a situation where the smartphone according to the first embodiment and the IC recorder are used in cooperation.

FIG. 6 is a block diagram showing an outline of the configuration example of a control system according to a second embodiment.

FIG. 7 is a schematic diagram showing an example of the configuration of the control system including the smartphone, the IC recorder and a lens-type camera according to the second embodiment.

FIG. 8A is a flowchart showing an example of smartphone control processing according to the second embodiment.

FIG. 8B is a flowchart showing an example of the smartphone control processing according to the second embodiment.

FIG. 9 is a flowchart showing an example of camera control processing according to the second embodiment.

FIG. 10 is a flowchart showing an example of IC recorder control processing according to the second embodiment.

### DETAILED DESCRIPTION OF THE INVENTION

### First Embodiment

### <Configuration of Control System>

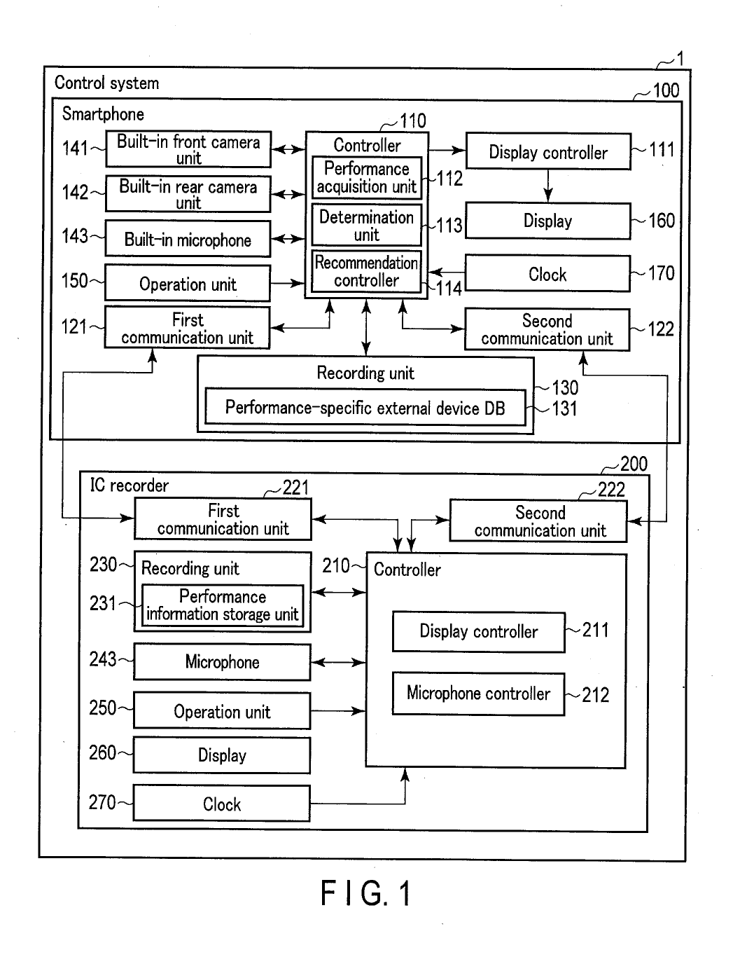

The first embodiment of the present invention will be described. The outline of the configuration example of a control system 1 according to the first embodiment is shown in FIG. 1 as a block diagram, and the configuration of the control system 1 according to the present embodiment will be described with reference to FIG. 1. The control system 1 according to the present embodiment includes a smartphone 100 as a control apparatus and an IC recorder 200 as an external device.

In the following, a case where the smartphone 100 according to the present embodiment functions as a control apparatus, and the IC recorder 200 functions as an external device for the smartphone 100, will be explained as an example. In the control system 1, the control apparatus includes a built-in function execution unit which includes, as a built-in function, a predetermined function and is configured to execute the built-in function. The external device includes at least one external function execution unit configured to execute the same function as the built-in function. In the present embodiment, the smartphone 100 has, as built-in functions, functions such as telephone call, transmission/reception of emails, photographing (image capture), and audio (sound) recording. The built-in function execution unit is hardware or software to execute these built-in functions. The IC recorder 200 has, as an external function execution unit, a configuration for executing an audio recording function. The external function execution unit is hardware or software to execute an external function. The smartphone 100 and the IC recorder 200 communicate with each other.

The smartphone 100 comprises a controller 110, a display controller 111, a first communication unit 121, a second communication unit 122, a recording unit 130, a built-in front camera unit 141, a built-in rear camera unit 142, a built-in microphone 143, an operation unit 150, a display 160, and a clock 170.

The controller 110 controls the operation of each component in the smartphone 100. The display controller 111 generates display information based on, for example, information obtained by the smartphone 100 and outputs the display information to the later-described display 160. The display controller 111 may take charge of image processing related to displaying an image, for example, resizing.

The controller 110 comprises a performance acquisition unit 112, a determination unit 113, and a recommendation controller 114. The performance acquisition unit 112 acquires, as a built-in function performance, for example, a performance of a built-in function execution unit of the smartphone 100, and acquires, as an external function performance, for example, a performance of the external function execution unit of the IC recorder 200, respectively. The performance acquisition unit 112 acquires the built-in function performance of the smartphone 100 by reading information recorded in the smartphone 100, or by referring to or searching for a database constructed in a server, the Internet, etc. from a model number, etc. of the smartphone 100. The performance acquisition unit 112 acquires the external function performance by reading information recorded in the IC recorder 200, or by referring to or searching for a performance-specific external device Data Base (DB) 131 from a model number, etc. of the IC recorder 200. The database referred to and searched for by the performance acquisition unit 112 is not limited to the performance-specific external device DB 131, and may be a database constructed in a server, the Internet, etc. The performance acquisition unit 112 may acquire, as a built-in function performance or an external function performance, a performance obtained by determining the quality, etc. of information obtained, for example, by operating the built-in function or external function. There are various performances for each of the units. Examples of the performance of an information acquiring circuit or a system include wavelength characteristics, sensitivity, directivity, a S/N ratio, a gain, a sampling frequency of A/D conversion, resolution or dynamic range of the A/D conversion, frequency characteristics, a recording method, temperature/humidity characteristics, a battery performance, and an energy-saving performance. In determining a situation or a scene where the smartphone 100 is used, a user need, etc., or in comparing a built-in function performance with an external function performance, etc., the controller 110 may use any one of them or may use them in combination. This enables determination of various required performances. The determination unit 113 determines whether or not the smartphone 100 has a sufficient performance to execute a built-in function in its operational situation, for example, whether or not the smartphone 100 has been able to obtain an image with an appropriate image quality, and whether or not the smartphone 100 has been able to acquire audio data with an appropriate sound quality and an appropriate sound volume. The determination unit 113 determines, for example, which of a built-in function performance and an external function performance has a higher performance for a comparative predetermined function. The recommendation controller 114 refers to a result of the determination in accordance of a situation when the function is executed, for example, during the time when the built-in function execution unit is executing a built-in function of the smartphone 100. If the external function performance is higher than the built-in function performance in the determination by the determination unit 113, the recommendation controller 114 recommends to a user the use of an external device having the external function performance.

The first communication unit 121 and the second communication unit 122 are included, for example, in the communication unit of the smartphone 100. The first communication unit 121 communicates with the IC recorder 200, using a communication protocol with low-consumption power such as Bluetooth Low Energy (BLE), Near Field Communication (NFC), and ZigBee. Hereinafter, a communication performed via the first communication unit 121 included in the smartphone 100 is referred to as a first communication. The second communication unit 122 included in the smartphone 100 communicates with, for example, the IC recorder 200, using a high-speed communication protocol as compared to the first communication, for example, Wi-Fi. Hereinafter, a communication performed via the second communication unit 122 of the smartphone 100 is referred to as a second communication.

In the recording unit 130, various settings and information related to operations of the smartphone 100, and information obtained from the IC recorder 200 are recorded. Each of the built-in front camera unit 141 and the built-in rear camera unit 142 includes, for example, an image sensor and an imaging optical system, and has a photograph function to generate an image based on a subject image formed on an imaging surface of each of the image sensors and to output the image. In the present embodiment, both the built-in front camera unit 141 and the built-in rear camera unit 142 perform the photograph function in a similar manner, but they are arranged in different locations so that different directions can be photographed. The built-in microphone 143 includes, for example, a microphone element, and executes an audio recording function to collect sounds and output audio data. The audio data is not limited to human voices, and includes every sounds collected. The operation unit 150 includes, for example, a press button, and a touch panel. The operation unit 150 obtains, for example, a result of a user's operation, and generates an operational signal based on this result to output it to the controller 110. The display 160 includes, for example, a liquid crystal display and performs a display based on display information generated by the display controller 111. The clock 170 generates time information to output it to the controller 110. The time information is used, for example, in recording of obtained data. The built-in function execution unit includes, for example, a built-in front camera unit 141, a built-in rear camera unit 142, and a built-in microphone 143.

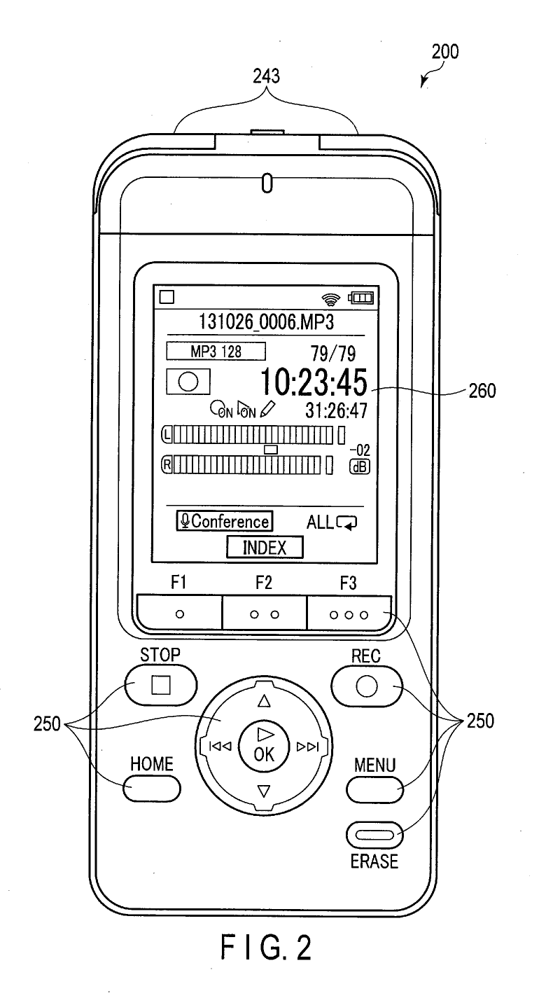

Herein, an example of the outline of an exterior appearance of the IC recorder 200 according to the first embodiment is shown in FIG. 2 as a schematic diagram, and the configuration of the IC recorder 200 will be explained with reference to FIGS. 1 and 2.

The IC recorder 200 includes a controller 210, a recording unit 230, a microphone 243, an operation unit 250, and a clock 270. The controller 210 controls the operation of each component in the IC recorder 200. The controller 210 includes a display controller 211 and a microphone controller 212. The display controller 211 generates, for example, display information based on information obtained by the IC recorder 200, display information related to an operation of the IC recorder 200 to output the display information, etc. to a later-described display 260. The microphone controller 212 performs control related to an operation of the microphone 243 of the IC recorder 200. For example, information obtained when an audio recording function of the IC recorder 200 is executed, information related to an operation of each component of the IC recorder 200, etc. is recorded in the recording unit 230. The microphone 243 includes, for example, a microphone element to execute the audio recording function of the IC recorder 200. The operation unit 250 obtains a result of a user's operation. The operation unit 250 includes, for example, a press button, a dial, a slider, and a touch panel, etc. The display 260 includes, for example, a liquid crystal display, to perform a display based on display information generated by the display controller 211. The clock 270 outputs time information. The external function execution unit includes, for example, the microphone 243.

The IC recorder 200 further includes a first communication unit 221 and a second communication unit 222. The first communication unit 221 communicates with the first communication unit 121 of the smartphone 100 via the first communication. The first communication includes transmission/reception of a control signal between the smartphone 100 and the IC recorder 200, for example. The second communication unit 222 communicates with the second communication unit 122 of the smartphone 100 via the second communication. The second communication includes, for example, transmission/reception of data obtained by the IC recorder 200 between the smartphone 100 and the IC recorder 200, for example.

The built-in function of the smartphone 100 is not limited to the above-mentioned photograph function and sound recording function, and may include, for example, a display function, a playback function of sounds or images, a telephonic function, an email function, etc. The functions that can be executed by external devices including the IC recorder 200 are referred to as external functions. The external functions of the IC recorder 200 are not limited to the above-mentioned sound recording function, and may include, for example, a display function, a playback function of sounds or images, etc.

In the following, among a plurality of functions possessed by the smartphone 100, a function having an external device provided with an external function execution unit configured to execute the same function as that of the built-in function execution unit of the smartphone 100 is referred to as a specific function. Among a plurality of functions possessed by the external device, a function corresponding to the specific function is referred to as a specific external function. In the present embodiment, besides the IC recorder 200, an external camera that can communicate with the smartphone 100 is present. In the present embodiment, explanations are made on the assumption that for example, among built-in functions of the smartphone 100, the photograph function and the sound recording function are included in specific functions, and the sound recording function of the IC recorder 200 is included in specific external functions.

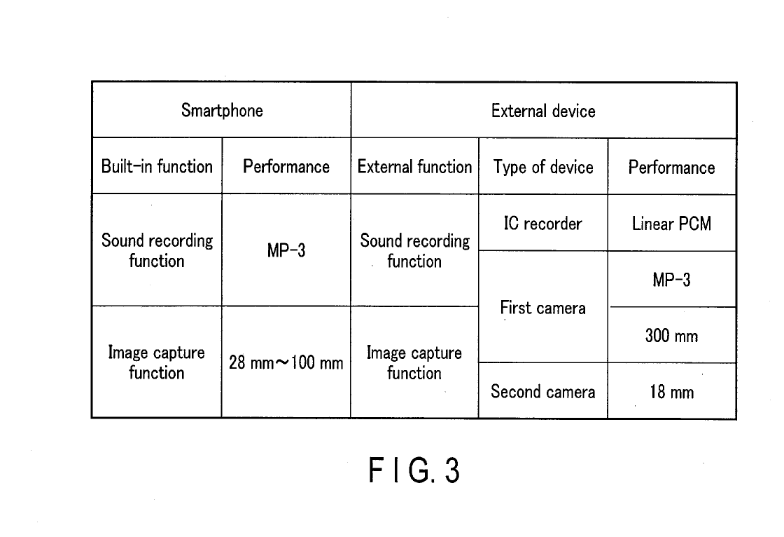

In the recording unit 130 of the smartphone 100, a performance-specific external device Data Base (DB) 131 is provided. An example of the configuration of the performance-specific external device DB 131 according to the first embodiment is shown in FIG. 3. As illustrated in FIG. 3, in the performance-specific external device DB 131, for example, a specific function of the smartphone 100 and its performance, a specific external function similar to the specific function, its performance, etc. are recorded. In the present embodiment, for example, it is recorded that as a performance of the sound recording function of the smartphone 100, sound recording in MP-3 format is enabled, and as a performance of the image capture (photography) function, it is recorded that photographing at a focal distance of 28 mm to 100 mm is enabled. For example, as a performance of the sound recording function of the IC recorder 200 as an external device, it is recorded that sound recording in a linear PCM format is enabled. For example, as a performance of an image capture (photography) function of a first camera, which is an external device, it is recorded that photographing with a focal distance of 300 mm is enabled, and as a performance of a sound recording function, it is recorded that sound recording in MP-3 format is enabled. For example, as a performance of a photograph function of a second camera, which is an external device, it is recorded that photographing with a focal distance of 18 mm is enabled. Information included in the performance-specific external device DB 131 includes information related to icons indicating each of specific external functions. In the present embodiment, the smartphone 100 as a control apparatus obtains the information through communications with the IC recorder 200, first camera, or second camera, which are external devices.

Herein, referring to FIG. 1 again, explanations on the configuration of the control system 1 according to the present embodiment will be continued. The recording unit 230 included in the IC recorder 200 includes a performance information storage unit 231. In the performance information storage unit 231, information related to specific external functions possessed by the specific external device is recorded. For example, in the present embodiment, information recorded in the performance information storage unit 231 includes a performance of the sound recording function of the IC recorder 200. The performance of the sound recording function includes various performances. Examples thereof include sensitivity, directivity, a S/N ratio, a gain, a sampling frequency of A/D conversion, resolution or dynamic range of the A/D conversion, frequency characteristics, a recording method, temperature/humidity characteristics, a battery performance, and an energy-saving performance. In the determination of a situation or a scene where the smartphone 100 is used, or a user's need, etc., or in a comparison between a built-in function performance and an external function performance, the controller 110 may use any one of them or may use them in combination. With this, various requested performances can be determined. Each of these various performances may be streamlined by standardization so as to be comparative with a similar function of the smartphone 100, or may be inferred from information obtained by the smartphone 100 by accessing a built-in or an external database by, for example, a model name of the external device.

Each of the recording unit 130 of the smartphone 100 and the recording unit 230 of the IC recorder 200 has a nonvolatile memory, such as a flash memory, and they may further have a volatile memory, such as a Static Random Access Memory (SRAM) and a Dynamic Random Access Memory (DRAM). Each of the recording unit 130 of the smartphone 100 and the recording unit 230 of the IC recorder 200 may consist of one memory, etc., or may consist of a plurality of memories in combination.

Each of the controller 110 and the display controller 111 of the smartphone 100, and the controller 210 and the display controller 211 of the IC recorder 200 includes an integrated circuit, such as a Central Processing Unit (CPU), an Application Specific Integrated Circuit (ASIC), a Field Programmable Gate Array (FPGA), a Digital Signal Processor (DSP) or a Graphics Processing Unit (GPU), etc. Each of the controller 110 and the display controller 111 of the smartphone 100, and the controller 210 and the display controller 211 of the IC recorder 200 may consist of one integrated circuit, etc., or may consist of a combination of two or more integrated circuits. The controller 110 of the smartphone 100 and the display controller 111 may consist of one integrated circuit, etc. The operations of these integrated circuits are executed, for example, in accordance with programs recorded in a recording region provided in, for example, the recording unit 130 of the smartphone 100, the recording unit 230 of the IC recorder 200, or an integrated circuit, etc.

### <Operation of Control System>

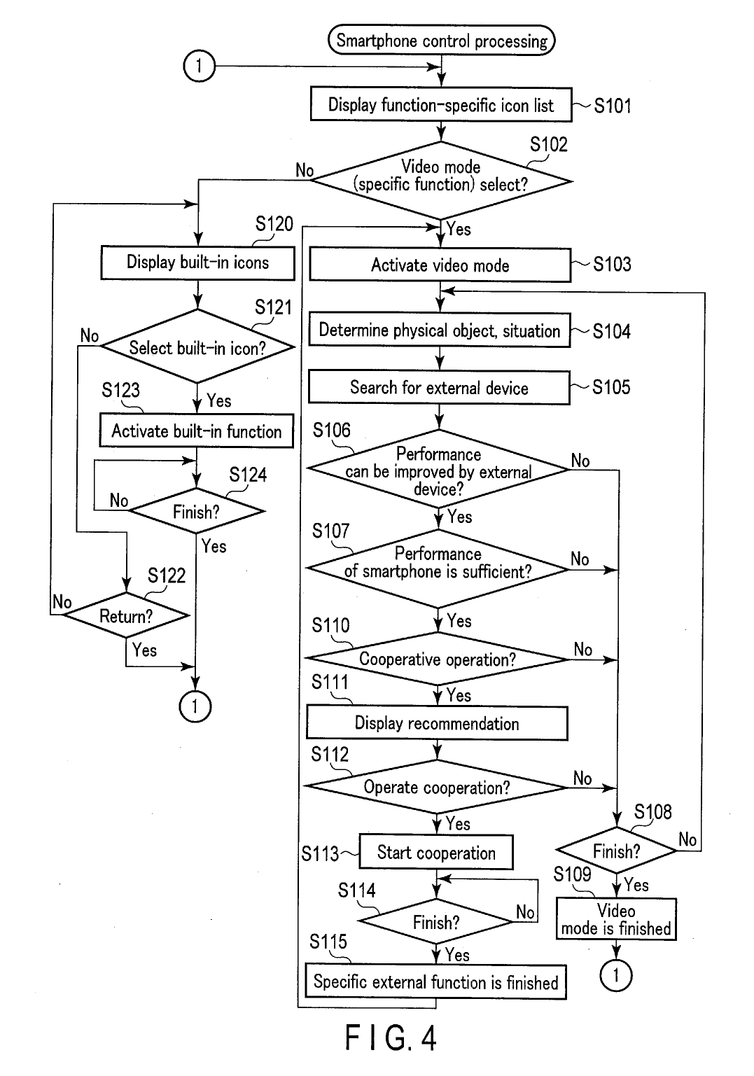

An example of a smartphone control processing according to the first embodiment is illustrated as a flow chart in FIG. 4, and the operation of the control system 1 according to the present embodiment will be explained with reference to the flowchart. Herein, suppose the IC recorder 200 is in a stand-by state for a first communication.

In step S101, the controller 110 causes the display 160 to display a list of icons respectively indicating the built-in functions of the smartphone 100, i.e., function-specific icons. The processing in this step is performed when the power of the smartphone 100 is turned on, or when a sleep state is canceled, for example.

In step S102, the controller 110 determines whether an icon indicating a specific function among a plurality of icons displayed in step S101 is selected or not based on an output from the operation unit 150 in accordance with a user's operation. The processing in this step is executed when a user selects any of the function-specific icons in step S101, for example. The controller 110 determines whether the function indicated by the selected icon is a specific function or not, referring to, for example, the recording unit 130. The selection of an icon by a user can be represented as a selection of a function indicated by an icon by a user. The processing proceeds to step S120 when it is determined that a built-in function other than a specific function is selected, and proceeds to step S103 when it is determined that a specific function is selected.

In the present embodiment, an example of a case where the user operates the smartphone 100 in step S102 to execute a video mode will be explained. The video mode is a function in which for example, videography is executed, and is a function included in specific functions.

In step S103, the controller 110 activates, for example, a built-in front camera unit 141 or a built-in rear camera unit 142, and a built-in microphone 143 to execute the video mode selected in step S102. Hereinafter, an example will be explained of a case where of the built-in front camera unit 141 and the built-in rear camera unit 142, for example, the built-in rear camera unit 142 is activated. The controller 110 starts a live view display based on an image to be taken by the built-in rear camera unit 142. In accordance with a user's operation, the operation of videography (image capture) by the built-in rear camera unit 142 is started at this time.

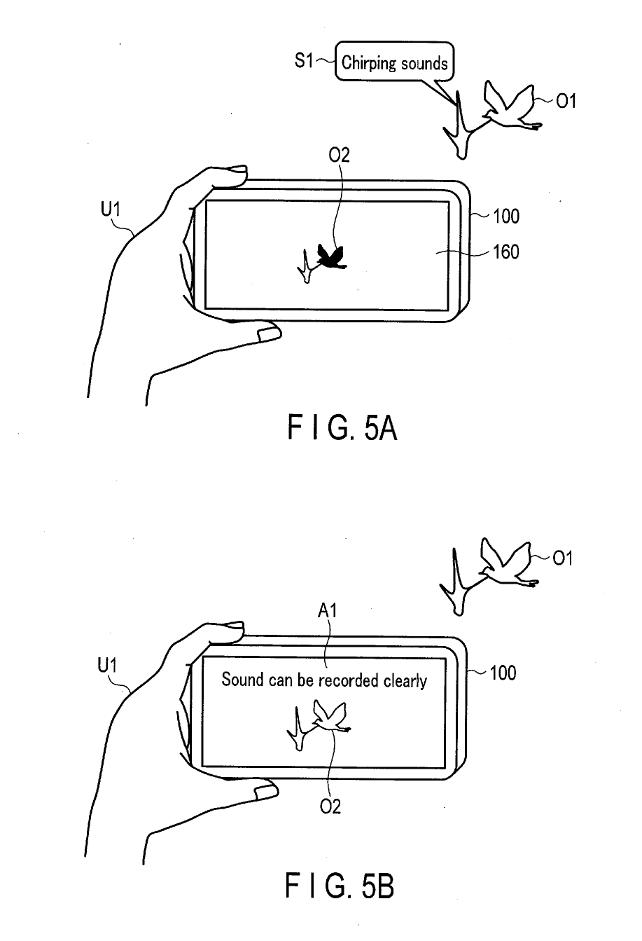

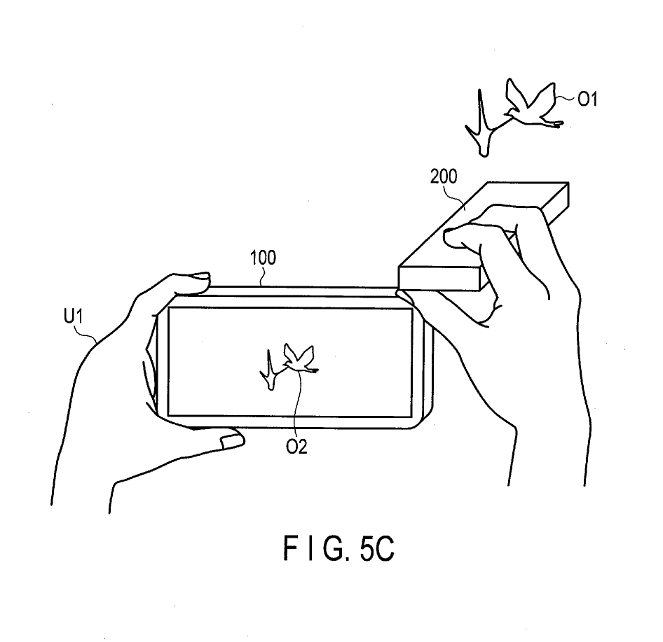

In step S104, the controller 110 analyzes, for example, an image and a sound obtained by, for example, execution of a selected video mode. Herein, a situation when a video mode of the smartphone 100 according to the first embodiment is selected is shown in FIG. 5A as a schematic diagram. At this time, suppose a user U1 is about to start videography (image capture) using the smartphone 100 with a bird O1 singing with its chirping sounds S1 as a subject of interest. In such a case, the controller 110 analyzes an image taken by the built-in rear camera unit 142 and a sound obtained by the built-in microphone 143, determines an object the user U1 wants to take a movie, and identifies the bird O1 as subject of interest. Afterward, the controller 110 determines, for example, whether or not the image has an appropriate image quality, or has a composition suitable for the bird O1, whether or not the audio data has caught the chirping sound S1 of the bird O1 with an appropriate sound quality, an appropriate sound volume, etc. The controller 110 further identifies a property required in execution of the video mode as a requirement related to performance from, for example, a user's operation, a use status of the smartphone 100, a scene where the smartphone 100 is used, etc. and obtains, as a performance-related requirement, a degree of performance required as the performance requirement.

Referring to FIG. 4 again, the explanation of the operation of the control system 1 according to the present embodiment will be continued. In step S105, the controller 110 causes, for example, the first communication unit 121 to perform the first communication with an external device to obtain an external device performance from the external device. At this time, the controller 110 obtains, through the first communication, information on whether the external device is in a usable state or not. The controller 110 records this information in the performance-specific external device DB 131. In the first communication, Bluetooth Low Energy (BLE), which consumes less power and can be constantly set as communication enabled (a stand-by mode, etc.), may be used for a wireless communication. A BLE communication is mainly a command communication, and such a communication period of a command communication is transitory; thus, it is possible to switch a communication network from one to another, and to conduct a sequential search for a communication partner if a BLE communication is utilized.

Hereinafter, explanations will be continued using an example of a case where in step S105, it is detected, for example, that the bird O1 is a subject the user wants to take a movie of, and that the bird O1 is singing, etc., and it is determined that a property required for performing videography with the bird O1 as a subject is sound recording with an appropriate sound quality.

In step S106, the controller 110 determines whether there is an external device which can record a sound with high sound quality, i.e., the external device satisfying the performance-related requirement, or not by referring to the performance-specific external device DB 131 and comparing the performance of the built-in microphone 143 with an external function performance of an external function execution unit. The controller 110 determines whether the performance can be improved in cooperation with the external device or not by such a determination. The processing proceeds to step S107 when it is determined that the performance can be improved, or proceeds to step S108 when it is determined that the performance cannot be improved.

In step S107, the controller 110 determines whether or not the performance of the built-in rear camera unit 142 or built-in microphone 143 of the smartphone 100 in a present state satisfies, as a performance-related requirement, the required performance requirement based on the result of the analysis in step S104. Namely, the controller 110 determines what performance requirement is requested in accordance with, for example, the present state of the smartphone 100, and determines whether or not the smartphone 100 satisfies the performance requirement. The processing proceeds to step S108 when it is determined that the performance requirement is satisfied, or proceeds to step S110 when it is determined that the performance requirement is not satisfied. The controller 110 may be configured to start an operation of the videography by the built-in rear camera unit 142 before the processing proceeds to step S108 after step S106 or step S107.

Herein, the determination on whether or not the smartphone 100 satisfies the performance request is simply described as “in accordance with the state” so that it can be easily understood in step S107, however; various performance-improving strategies may be included in the determination. This “state” is determined in accordance with a state of an object, a function selected by a user, various performances related to the function (sensitivity, directivity, a S/N ratio, a gain, a sampling frequency of A/D conversion, resolution or dynamic range of the A/D conversion, frequency characteristics, a recording method, temperature/humidity characteristics, a battery performance, an energy-saving performance, etc.), characteristics such as a process or a procedure of an operation, etc. The determination may be performed in accordance with one of the things above mentioned. For example, when the battery consumption of the smartphone 100 is heavy, and if there is an external device having a corresponding function and the external device has a sufficient battery power, the function presently executed by the smartphone 100 may be taken over and executed by the external device, regardless of a result of comparison of other performance. This is an example of enabling a recommendation by an extremely simple determination.

In step S108, the controller 110 determines whether or not the video mode should be finished based on, for example, an output of the operation unit 150 in accordance with a user's operation. The processing returns to step S104 when it is determined that the processing should not be finished, to execute the video mode until it is determined that the processing should be finished in step S108. The processing proceeds to step S109 when it is determined that the processing should be finished. In step S109, the controller 110 finishes the activated built-in rear camera unit 142 and built-in microphone 143 to finish the video mode. Afterward, the processing returns to step S101.

In step S110, the controller 110 determines whether or not the smartphone 100 and the external device can execute the video mode in cooperation, for example, based on the information obtained in step S105. What is determined in this step as being that they are unable to cooperate includes a case where the external device is not in a usable state, such as a case where the external device is not presently present in the user U1's immediate vicinity, a case where the second communication cannot be established, although the external device is present, etc. The processing proceeds to step S111 when it is determined that they can cooperate, or proceeds to step S108 when it is determined that they cannot cooperate. Whether or not the second communication can be established may be determined when the cooperation is selected by a user and the cooperation is started.

For example, according to the performance-specific external device DB 131 of the present embodiment explained referring to FIG. 3, the IC recorder 200 and the first camera have sound recording functions. Suppose that the built-in function of the smartphone 100 does not satisfy the performance requirement, the sound recording function of the first camera is sound (audio) recording in a MP-3 format similar to the sound recording function of the smartphone 100, and no improvement in sound quality is expected. On the other hand, the sound recording function of the IC recorder 200 is sound (audio) recording in a linear PCM format, and an improvement in sound quality is expected. In such a case, the controller 110 determines that the performance of the sound recording of the IC recorder 200 is high as compared to the performance of sound recording of the smartphone 100 in the present status of use. Hereinafter, an example of a case where the IC recorder 200 is determined as a cooperative external device will be explained.

In step S111, the controller 110 causes the display 160 to display the display information for recommending use of the IC recorder 200 to the user U1. Herein, a situation where the IC recorder 200 is recommended by the smartphone 100 according to the first embodiment is shown in FIG. 5B as a schematic diagram. As illustrated in FIG. 5B, the controller 110 displays, for example, a notification A1 “sound can be recorded clearly”, on the display 160. Therefore, if the user U1 looks at the notification A1 to see that the IC recorder 200 should be used. In step S112, the controller 110 determines whether or not the user U1 has chosen to use the smartphone 100 in corporation with the recommended IC recorder 200 based on, for example, an output of the operation unit 150 according to an operation of the user U1. The processing proceeds to step S113 when it is determined that the cooperation should be performed, or proceeds to step S108 when it is determined that the cooperation should not be performed.

In step S113, the controller 110 starts a video mode by the smartphone 100 and the IC recorder 200. The controller 110 causes the first communication unit 121 to transmit a control signal to start the operation of the IC recorder 200 via the first communication. The controller 110 causes the second communication unit 122 to establish the second communication with the IC recorder 200 to obtain audio data collected by the IC recorder 200 via the second communication. Herein, an example of a situation of the cooperation between the smartphone 100 according to the first embodiment and the IC recorder 200 is shown in FIG. 5C as a schematic diagram. As illustrated in FIG. 5C, the user U1 can perform video shooting of a subject of interest the user wants to take a video with an appropriate image quality and an appropriate sound quality by using the smartphone 100 in cooperation with the IC recorder 200 recommended for use.

Referring to FIG. 4 again, the explanation of the operation of the control system 1 according to the present embodiment will be continued. In step S114, the controller 110 determines whether the cooperation between the smartphone 100 and the IC recorder 200 should be finished or not based on, for example, an output of the operation unit 150 in accordance with a user's operation. The processing continues the cooperation until it is determined that the cooperation should be finished in this step, when it is determined that the cooperation should not be finished, or proceeds to step S115 when it is determined that the cooperation should be finished. In step S115, the controller 110 transmits a control signal for finishing the operation of the IC recorder 200 via the first communication to finish the cooperation. Afterward, the processing returns to step S103. It should be noted, however, the processing may be configured to proceed to step S108 after it is determined that the cooperation should not be performed in step S112 and the processing to finish the cooperation is performed in step S115.

If a built-in function other than a specific function is selected in step S102, the controller 110 causes the display 160 to display an icon indicating a function included in the selected built-in function in step S120. In step S121, the controller 110 determines whether any of the icons indicating the function displayed in step S120 or not based on, for example, an output of the operation unit 150 in accordance with a user's operation. The processing proceeds to step S123 when it is determined that an icon indicating any of the displayed functions is selected, or proceeds to step S122 when it is determined that the icon is not selected. In step S122, the controller 110 determines whether the processing should be returned to the display list of function-specific icons based on, for example, an output of the operation unit 150 in accordance with a user's operation. This step is performed, for example, when the operation unit 150 detects a user's operation, such as returning and finishing, or when the operation unit 150 does not detect a user's operation for a predetermined time period. The processing returns to step S101 when it is determined that the processing should return, or returns to step S120 when it is not determined that the processing should return.

In step S123, the controller 110 starts an operation related to the built-in function selected in step S121. In step S124, the controller 110 determines whether or not the operation of the built-in function should be finished in accordance with a user's operation, for example. The processing continues the processing related to the operation of the built-in function until it is determined that the operation should be finished in this step when it is determined that the operation should not be finished, or when it is determined that the operation should be finished, the processing for finishing the operation of the built-in function is performed, and the processing returns to step S101.

In the present embodiment, it is explained above that when the performance of the smartphone 100 is insufficient, for example, as a result of referring to the performance-specific external device DB 131, an external device having a higher performance is searched for if present, however; the embodiment is not limited thereto. The technique according to the present embodiment, whether or not it is in a condition where an external device capable of improving the performance is available may be searched for at the time, for example, when it is determined that the performance of the smartphone 100 is insufficient. At this time, a performance acquisition unit 112 may acquire an external function performance from an external device via the first communication, for example. Furthermore, in the technique according to the present embodiment, a search may be performed at the time when a specific function of the smartphone 100 is selected. If an external device having a higher performance than that of the smartphone 100 is present, the smartphone 100 may be configured to recommend the external device, even if the performance of the smartphone 100 is not insufficient. If an external device satisfying a performance requirement is not in an available condition, the controller 110 may present the user that an improvement in performance can be expected by preparing the external device. In the present embodiment, an example of a case is presented where the smartphone 100 communicates with an external device to obtain information included in the performance-specific external device DB 131, however; the information may be recorded in the performance-specific external device DB 131 by a method other than the communication between the smartphone 100 and an external device.

In the present embodiment, an example of a case where a recommendation is displayed by text such as the notification A1 is explained, however; the display of recommendation is not limited thereto. A recommendation may be performed by displaying an icon indicating, for example, the IC recorder 200.

The present embodiment is explained, as candidates of an external device usable in cooperation with the smartphone 100, by presenting the IC recorder 200, the first camera, and the second camera, however; the embodiment is not limited thereto. The external device may be an electronic device capable of executing a specific external function and a communication function, and it may be one or more.

In the present embodiment, an example of a case where only the IC recorder 200 is recommended to a user as being able to cooperate with the smartphone 100 is explained, however; the embodiment is not limited thereto. For example, if a plurality of external devices determined to be able to cooperate are detected, the plurality of external devices may be recommended. At this time, the recommended external devices may be displayed in a list, or may be displayed sequentially based on, for example, an operation of the user's swiping. The order of priority of recommended external devices may be provided by, for example, superiority of performance. The order of priority may be preliminarily set by a user, or may be set based on an image quality, a sound quality, a remaining recordable time, a remaining battery charge, a user's past selection history, a user's frequency of use, etc.

As described above, the technique according to the present embodiment determines, when a function of the smartphone 100 selected by a user is executed, whether or not the performance of the smartphone 100 has a performance sufficient to execute the function in accordance with a situation when the function is executed. A result of the determination on which a built-in function performance and an external function performance, is higher for a comparative predetermined function, is referred to in accordance with a situation where a function is executed, for example, when a built-in function execution unit executes a function of the smartphone 100. If an external device capable of improving the performance related to execution of the function is present and it is determined that the built-in function execution unit of the smartphone 100 does not satisfy a required performance requirement, the technique according to the present embodiment recommends to the user cooperation between the smartphone 100 and the external device. Therefore, by using the smartphone 100 according to the present embodiment, the user can use an appropriate device and use a selected function, regardless of the performance of the smartphone 100.

The control system 1 according to the present embodiment can perform a communication of an instruction to start sound recording and a communication of a control signal related to an operation of the IC recorder 200, such as an operation to increase or decrease a gain via the first communication, for example, even when a communication is performed for audio data between the smartphone 100 and the IC recorder 200. Therefore, by using the control system 1 according to the present embodiment, the user can operate a specific external device including the IC recorder 200 while receiving acquisition data of the specific external device.

In the control system 1 according to the present embodiment, a control signal, etc. is transmitted and received via the first communication using, for example, BLE capable of communicating with low consumption power, and receives acquisition data of an external device via a second communication, for example, Wi-Fi, etc. As described above, the control apparatus according to the present embodiment communicates with the external device via two different types of the communication. Therefore, the control apparatus according to the present embodiment can sequentially perform transmission/reception of a control signal, etc., which is a transitory communication in the first communication, between different external devices, even when the second communication is occupied by, for example, a live view display.

For example, the second communication performed by the second communication unit 122 when the smartphone 100 cooperates with the IC recorder 200 is a successive communication including acquisition of continuous data which is obtained by the IC recorder 200. Since a through image is transmitted in the second communication, a Wi-Fi communication, etc., being large in communication volume, is assumed. The second communication is not a transitory exchange of information such as a simple access or response like the first communication using the BLE, etc. described above, and is a communication occupying a communication line in the sense of taking time and effort in establishing a communication as well as an aspect of sequentially transmitting a large volume of data. Even if the second communication such as Wi-Fi is occupied by data communication, etc., the first communication such as BLE can search for, as the other communication, other devices by freely changing a partner to access, etc.

In a circumstance where, for example, the second communication is not established, the control apparatus according to the present embodiment may obtain information including conditions for settings of an external device, a circumstance of data acquisition, etc. from an external device determined to be able to cooperate via the first communication, and based on the information, and display, as an auxiliary display, information related to data assumed to be obtainable when the control apparatus cooperates with the external device. The auxiliary display may be, for example, an external device performance. The auxiliary display may be a display of icons or a display of images, graphics, and text, etc.

### Second Embodiment

The second embodiment of the present invention is described. Herein, differences from the first embodiment will be described, and for elements specified by the same reference numbers/characters, a duplicate description of such elements will be omitted.

### <Configuration of Control System>

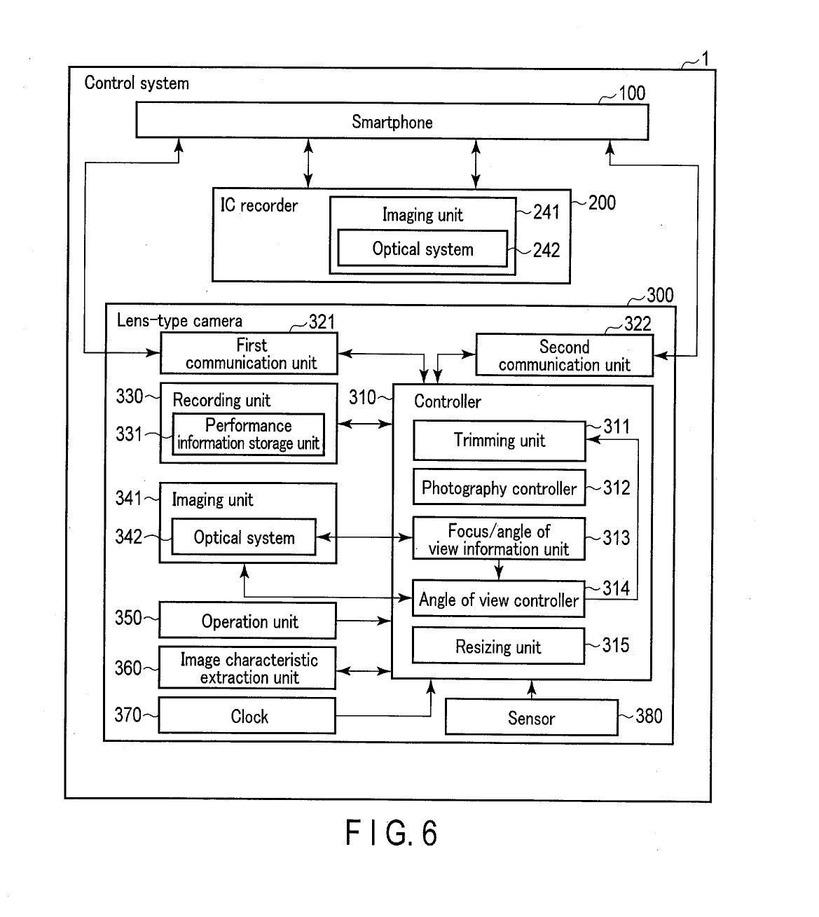

The outline of a configuration example of a control system 1 according to a second embodiment is shown in FIG. 6 as a block diagram, and the configuration of the control system 1 according to the present embodiment will be described with reference to FIG. 6. Hereinafter, the configuration and the operation of the control system 1 will be explained more specifically using an example when the control system 1 includes, for example, a smartphone 100, an IC recorder 200, and a lens-type camera 300.

Suppose that each of the units provided in the smartphone 100 and in the IC recorder 200 according to the present embodiment are the same as the first embodiment. The IC recorder 200 according to the present embodiment further includes an imaging unit 241. The imaging unit 241 includes an optical system 242. The imaging unit 241 further includes, for example, an image sensor and generates and outputs image data based on a subject image which is formed on an imaging surface of the image sensor by incident light entered via the optical system 242.

The lens-type camera 300 includes a controller 310, a recording unit 330, an imaging unit 341, an operation unit 350, an image characteristic extracting unit 360, a clock 370, and a sensor 380.

The controller 310 performs control related to an operation of each of the units of the lens-type camera 300. The controller 310 includes a trimming unit 311, a photography controller 312, a focus/angle of view information unit 313, an angle of view controller 314, and a resizing unit 315. The trimming unit 311 performs trimming on an image. The photography controller 312 performs, for example, various settings related to photography, and controls imaging performed by the imaging unit 341. The focus/angle of view information unit 313 obtains information of settings of a state of focus, an angle of view, etc. at the time of performing photography by the lens-type camera 300 based on an image obtained by the imaging unit 341. The angle of view controller 314 controls an angle of view of imaging performed by the imaging unit 341 based on an output of, for example, the focus/angle of view information unit 313. The resizing unit 315 performs resizing on, for example, the image obtained by the imaging unit 341.

In the recording unit 330, for example, information obtained when the imaging function of the lens-type camera 300 is executed, information related to an operation of each of the units of the lens-type camera 300, etc. is recorded. The recording unit 330 includes a performance information storage unit 331. In the performance information storage unit 331, information of functions of the lens-type camera 300, performances of the functions, and icons indicating the functions are recorded.

The imaging unit 341 includes an optical system 342. The imaging unit 341 further includes, for example, an image sensor, and generates and outputs image data based on a subject image formed on an imaging surface of the image sensor by incident light entered via the optical system 342. The operation unit 350 obtains a result of a user's operation. The operation unit 350 includes, for example, a press button, a dial, a slider, and a touch panel, etc. The image characteristic extracting unit 360 detects, for example, characteristics included in an image obtained by the imaging unit 341. The image characteristics extracted herein are used for subject recognition and identification, for example. The clock 370 outputs time information. The sensor 380 includes, for example, an electronic compass, an acceleration sensor, a brightness sensor, a GPS sensor, etc., and obtains and outputs a state of a housing and the periphery of the lens-type camera 300.

The lens-type camera 300 further includes a first communication unit 321 and a second communication unit 322. The first communication unit 321 communicates with the first communication unit 121 of the smartphone 100 via a first communication. The first communication includes, for example, transmission/reception of a control signal between the smartphone 100 and the lens-type camera 300. The second communication unit 322 of the lens-type camera 300 communicates with the second communication unit 122 of the smartphone 100 via a second communication. The second communication includes, for example, transmission/reception of obtained data of the lens-type camera 300 between the smartphone 100 and the lens-type camera 300.

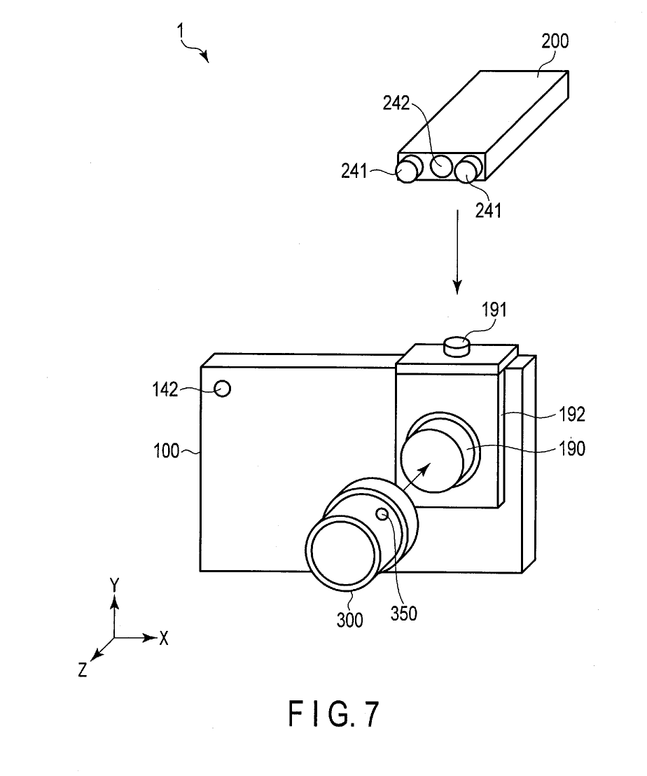

An example of the configuration of the control system 1 including the smartphone 100, the IC recorder 200, and the lens-type camera 300 according to the second embodiment is shown in FIG. 7 as a schematic diagram. The smartphone 100 may include an adopter 190 as shown in FIG. 7. At this time, the IC recorder 200 may be a recorder to be attached to the smartphone 100 via an IC recorder attachment unit 191 provided in the adopter 190. The lens-type camera 300 may be a camera to be attached to the smartphone 100 via a lens-type camera attachment unit 192 provided in an adopter 190.

In the performance-specific external device DB 131 according to the present embodiment, at least information of the IC recorder 200 and the lens-type camera 300 as external devices having imaging functions is recorded, and information of the IC recorder 200 as an external device having a sound recording function is recorded.

### <Operation of Control System>

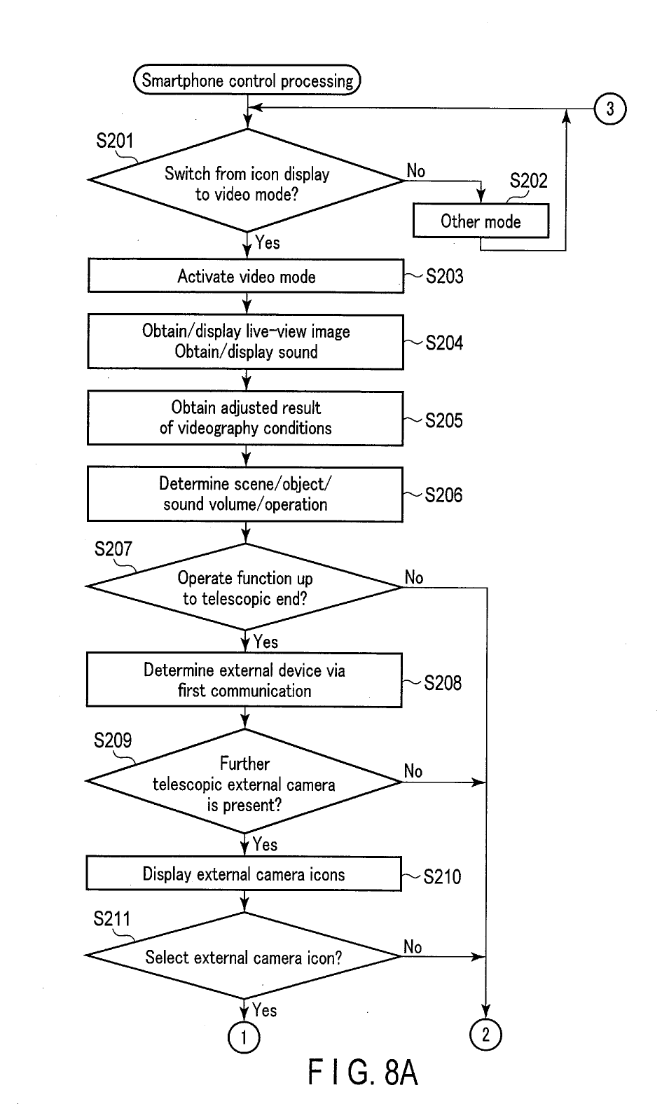

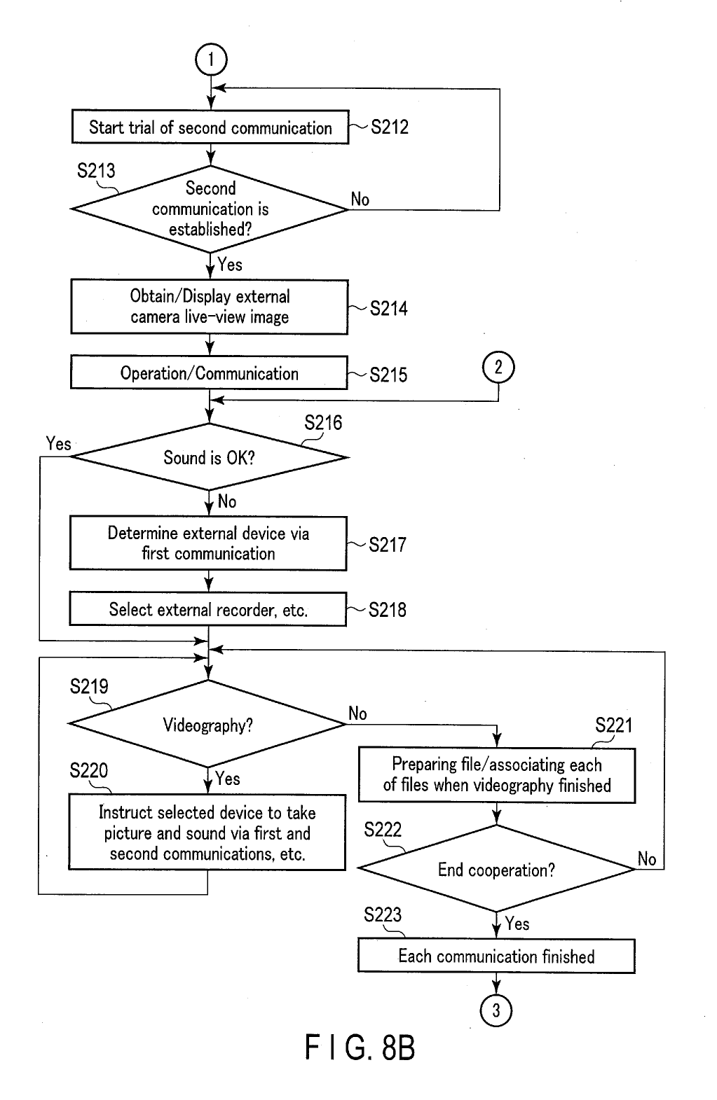

An example of the smartphone control processing according to the second embodiment is illustrated as a flowchart in FIGS. 8A and 8B, and the operation of control system 1 according to the present embodiment using an example where the video mode is selected will be described with reference to FIGS. 8A and 8B.

In step S201, the controller 110 displays a list of function specific icons and then determines whether the video mode is selected or not. The processing proceeds to step S202 when it is determined that the video mode is not selected, such as when a built-in function of the smartphone 100 other than the video mode is selected, or when nothing is selected, etc., or proceeds to step S203 when it is determined that the video mode is selected. In step S202, the controller 110 performs respective processing related to a selected built-in function of the smartphone 100. Afterward, the processing returns, for example, to step S201.

In step S203, the controller 110 activates respective units provided in the smartphone 100 for executing the video mode, since the video mode is selected. Hereinafter, an explanation will be continued using an example where the built-in rear camera unit 142 and the built-in microphone 143 are herein activated. In step S204, the controller 110 obtains an image from the built-in rear camera unit 142 and obtains audio data from the built-in microphone 143. The controller 110 causes a display controller 111 to generate display information based on the image and audio data obtained in the display controller 111 and causes the display 160 to start a live-view display. The display information based on the audio data includes, for example, information for displaying a bar, etc. indicating a sound volume or a sound level, information for informing the user that the sound is presently being obtained, etc.

In step S205, the controller 110 obtains operation history information related to what kind of videography conditions are adjusted by a user based on an output of the operation unit 150 according to a user's operation. The operation history information includes information of results of a user's operation, for example, a user has operated a focal distance to a telescopic side or a wide angle side, has increased or decreased a gain in sound acquisition, has adjusted exposure, etc. The operation history information may further include, for example, information that a user has operated the smartphone 100 up to the limitation of the performance thereof, such as a user has operated its focal distance up to the telescopic end or the wide-angle view end.

In step S206, the controller 110 determines a scene, a photographic object, a sound volume, or an operation based on the operation history information obtained in step S205. For example, the controller 110 determines whether or not the imaging sensitivity possessed by the smartphone 100 is sufficient in the present photographic environment, by the scene determination. For example, the controller 110 identifies a subject of interest the user is about to take a picture of and determines whether or not an image having a composition and an image quality suitable for the subject of interest has been obtained, or whether or not a voice given from the subject of interest has been obtained with a suitable sound quality, etc., by the object determination. For example, the controller 110 determines whether or not a voice given from the subject of interest has been obtained with a sufficient sound volume, by the sound volume determination. For example, the controller 110 determines under what photographic conditions the user intends to execute the video mode by the operation determination. For example, when the user has operated the gain of the voice acquisition up to a maximum value, the controller 110 determines that there is a possibility that the user may wish to execute the video mode with a further higher gain of the voice acquisition. The controller 110 determines whether or not the performance related to each of the built-in functions provided in the smartphone 100 is a performance sufficient to obtain a video image desired by the user in the photographic environment at that time by performing the determination processing.

As described above, the smartphone 100 according to the present embodiment communicates with an external device having an external function execution unit configured to execute the same function as that of a built-in function execution unit, obtains a performance of the built-in function execution unit as a built-in function performance, obtains a performance of the external function execution unit as an external function performance through the communication, determines which of the built-in function performance and the external function performance is higher for a comparable predetermined function, and refers to a result of the determination according to a situation of execution of the function when the built-in function execution unit executes the function. The order of determination of the situation, determination by a comparison of performances, and the communications therefor may, of course, be changed.

Hereinafter, an explanation will be continued using an example of a case where for example, in step S205 to step S206, the controller 110 recommends an external device having a further telescopic performance based on the user having operated the focal distance to its telescopic end.

In step S207, the controller 110 determines whether or not the user has operated zooming up to a telescopic end at which the performance of the videography function of the smartphone 100 can be realized up to its telescopic end. The processing proceeds to step S208 when it is determined that the zooming is performed up to the telescopic end, or proceeds to step S216 when it is determined that the zooming is not performed up to the telescopic end.

In step S208, the controller 110 refers to the performance-specific external device DB 131 and causes the first communication unit 121 to perform the first communication to determine whether or not an external device capable of photographing a further telescopic side as compared to the photography function of the smartphone 100 is present. In step S209, the controller 110 determines whether a further telescopic external device is detected or not based on the result of the determination in step S208. The processing proceeds to step S210 when it is determined that such an external device is detected, or proceeds to step S216 when it is determined that such an external device is not detected.

As described above, the smartphone 100, which is a control apparatus according to the present embodiment, may compare and determine performance according to a situation of execution of a function when the built-in function execution unit executes the function. The order of the determination of a situation, the determination by a performance comparison, and the communications therefor may, of course, be changed. The control apparatus according to the present embodiment communicates with an external device having an external function execution unit configured to execute the same function as that of the built-in function execution unit, obtains a performance of a built-in function execution unit as a built-in function performance, obtains a performance of an external function execution unit as an external function performance via the communication, and determines which of the built-in function performance and the external function performance is higher for a comparative predetermined function, however; the determination may be preliminarily performed. Making the determination preliminarily in this way eliminates the need for communicating many times. In the control apparatus according to the present embodiment, if a determination of a situation is performed sequentially, a result of the determination may be obtained beforehand through a communication, or a comparison may be performed through a communication by changing items to be compared according to the situation. Alternatively, a recommendation may be performed by determining preferences specific to a user, etc. rather than for each utilization situation.

In step S210, the controller 110 displays an icon indicating a detected external device on the display 160 to recommend the external device to the user. Hereinafter, an explanation will be continued using an example where, of the IC recorder 200 and the lens-type camera 300 recorded as an external device having a photography function in the performance-specific external device DB 131, the lens-type camera 300 is recommended. Therefore, in this step, the controller recommends to the user that a more telescopic videography is enabled by causing the smartphone 100 to cooperate with the lens-type camera 300 at the present situation. The need for telephotography or such a situation or a scene, is determined herein by the user's operation up to the telescopic end.

As described above, if an external function performance is higher than a built-in function performance required by the situation, scene, need, etc. (an external function is suitable for the situation or scene, or close to the need), there is a control apparatus including a recommendation controller 114 that recommends use of the external device and a performance acquisition unit 112 that acquires a performance of the external function execution unit as an external function performance through the communication, and thus the user is able to enjoy the use of a device with a higher performance. If described as needs, it appears that as if the user has a desire or thoughts from the beginning, however; it can also be said that a scene, an operation, etc. are determined in this step to give awareness to the user to extract a need therefrom. Explanations are clarified herein by descriptions through simplification of elements including a selected function and an operation state.

In step S211, the controller 110 determines whether or not an icon indicating the lens-type camera 300 displayed for recommendation in step S210 is selected, based on, for example, an output of the operation unit 150 according to a user's operation. The processing proceeds to step S212 when it is determined that the icon is selected, or proceeds to step S216 when it is determined that the icon is not selected.

Such a relationship between recommendation and selection is very important when a device or a system has artificial intelligence. The relationship can also be interpreted as a form like a communication between an apparatus or a system and its user. By repeating a question and an answer, the preferences of the user are learned by the artificial intelligence. As a result, a design idea can be provided in which results of the learning of the user's preferences are reflected in the next or subsequent recommended patterns or selections.

It is effective to prepare recommended data at the time of recommendation and a result of an actual selection so that they can be constantly learned or recorded, or input, for example, so that they can be extracted in a table format for each situation. In particular, it is difficult to collectively determine a situation, an operation, and/or a need, and thus an improvement in accuracy can be expected by using artificial intelligence.

In step S212, the controller 110 causes the second communication unit 122 to operate to establish the second communication between the smartphone 100 and the lens-type camera 300. The controller 110 generates a control signal to turn on the power source of the lens-type camera 300 and transmits it to the lens-type camera 300 via the first communication. In step S213, the controller 110 determines whether or not the second communication is established. When it is determined that the second communication is not established, the processing of step S212 continues until it is determined that the second communication is established in this step; when it is determined that the second communication is established the processing proceeds to step S214.

In step S214, the controller 110 obtains an image obtained by the lens-type camera 300 via the second communication, and displays a live-view image on the display 160 based on the image. The controller 110 finishes the photography function by the built-in rear camera unit 142 of the smartphone 100 which has been activated so far.

In step S215, the controller 110 generates a control signal to operate the lens-type camera 300 based on, for example, an output of the operation unit 150 according to a user's operation, and transmits the control signal to the lens-type camera 300 via the first communication. The controller 110 obtains, after an operation based on the control signal, the image obtained by the lens-type camera 300 via the second communication and causes the display 160 to display a live-view display based on the image. Therefore, the user can operate the lens-type camera 300 while looking at the live-view image to which the operation has been applied.

In step S216, the controller 110 determines whether or not a state of acquisition of audio data is favorable. The processing proceeds to step S219 when it is determined that the acquisition sate is favorable, or proceeds to step S217 when it is determined that the acquisition state is not favorable.

In step S217, the controller 110 determines whether or not an external device having a high sound collecting (recording) performance as compared to the built-in microphone 143 of the smartphone 100 is present in a similar manner to step S208, for example.

In step S218, the controller 110 determines whether the external device is present or not. The processing proceeds to step S219 without performing the processing in this step when it is determined that the external device is not present. On the other hand, when it is determined that the external device is present, the controller 110 displays an icon indicating the external device in a similar manner to step S210 and determines in a manner similar to step S211 whether or not the icon is selected. Herein, when it is determined that the icon is selected, the same processing as in step S214 and step S215 is performed on the external device, since the second communication has been established. Afterward, the processing proceeds to step S219.

Hereinafter, an explanation will be continued using an example where the IC recorder 200 is recommended in step S218 and is selected by the user. Note that if the control apparatus does not cooperate with any of external devices, a videography operation is executed by, for example, the built-in rear camera unit 142 and the built-in microphone 143 of the smartphone 100.

In step S219, the controller 110 determines whether or not to perform the videography based on, for example, an output of the operation unit 150 in accordance with a user's operation. The processing proceeds to step S220 when it is determined that the videography is performed, or proceeds to step S221 when it is determined that the videography is not performed.

In step S220, the controller 110 generates a control signal to cause the IC recorder 200 selected as being cooperative to start sound collecting (recording) and generates a control signal to cause the lens-type camera 300 selected as being cooperative to start image capture. The controller 110 transmits each control signal to each of the devices via the first communication or the second communication to start videography. Afterward, the processing returns to step S219 and continues the processing until it is determined that the videography is not performed.

In step S221, if the videography has been executed, the controller 110 forms video data and audio data obtained by the videography into a file and record the data in the recording unit 130. Furthermore, the controller 110 associates the audio data collected by the IC recorder 200 with the video data taken by the lens-type camera 300. In place of the associating, the audio data collected by the IC recorder 200 and the video data taken by the lens-type camera 300 may be recorded into one file.

In step S222, the controller 110 determines whether the cooperation with the IC recorder 200 and the lens-type camera 300 should be finished or not based on, for example, an output of the operation unit 150 in accordance with a user's operation. The processing proceeds to step S223 when it is determined that the cooperation should be finished, or returns to step S219 when it is determined that the cooperation should not be finished. In step S223, the controller 110 finishes the first communication and the second communication between the smartphone 100, and IC recorder 200 and lens-type camera 300. Afterward, the processing proceeds to step S201.

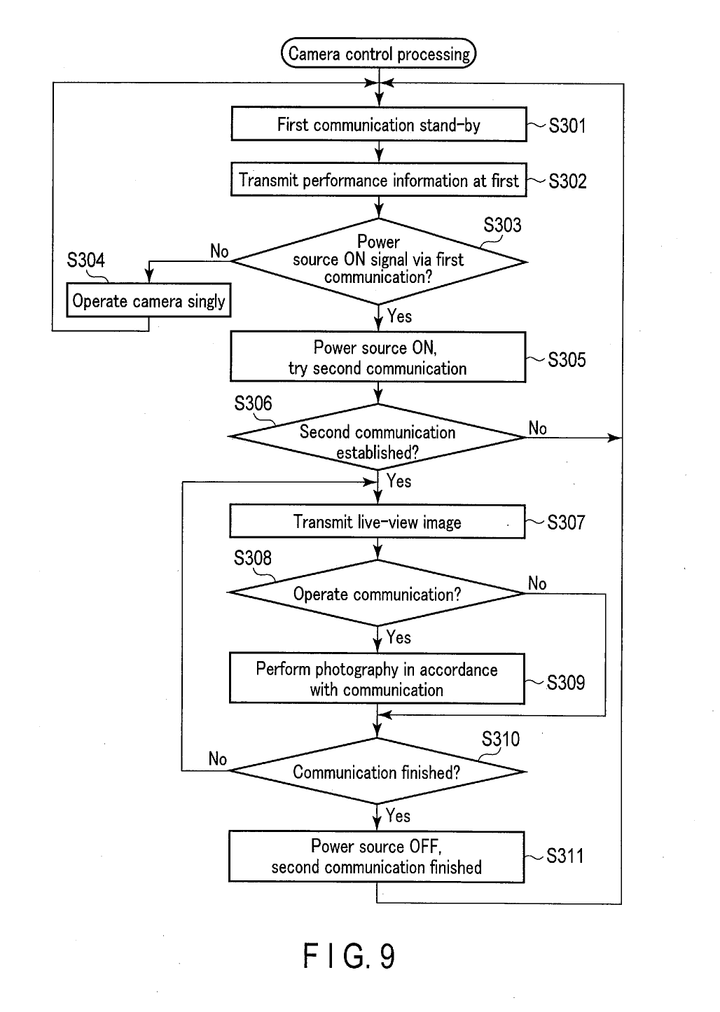

An example of a camera control processing executed by the lens-type camera 300 according to the second embodiment is shown as a flowchart in FIG. 9. Hereinafter, referring to FIG. 9, the operation of the control system 1 according to the present embodiment will be explained using an example where the lens-type camera 300 is used in cooperation with the smartphone 100.

In step S301, a controller 310 causes a lens-type camera 300 in a stand-by state until it receives the first communication transmitted from the smartphone 100. The processing proceeds to step S302 when it receives the first communication from the smartphone 100.

In step S302, the controller 310 determines whether or not performance information is requested by the first communication transmitted from the smartphone 100. The controller 310 reads performance information of itself from a performance information storage unit 331 when it is determined that the performance information is requested, and transmits it to the smartphone 100 via the first communication. The processing is not performed when it is determined that the information is not requested. The operation of this step corresponds to step S208. The operation of this step may be performed when performance information is not requested.

In step S303, the controller 310 determines whether or not a control signal to turn on the power source in the first communication is received from the smartphone 100. The processing proceeds to step S305 when it is determined that the control signal is received, or proceeds to step S304 when it is determined that the control signal is not received. The operation of this step corresponds to step S212.

In step S304, the controller 310 causes the lens-type camera 300 to operate alone based on, for example, an output of the operation unit 350 in accordance with a user's operation. The processing of this step is performed, for example, when the user uses the lens-type camera 300 alone when the cooperation between the smartphone 100 and the lens-type camera 300 is not performed. The processing returns to step S301 when the operation of the lens-type camera 300 is finished, such as when the user finishes use of the lens-type camera 300, and when the lens-type camera 300 is not used in step S304, etc. The processing of this step may be configured to finish when the controller 310 has received the first communication.

In step S305, the controller 310 turns on the power source of the lens-type camera 300 based on the control signal received via the first communication. The controller 310 starts an operation to establish a second communication. The processing of this step corresponds to step S212.

In step S306, the controller 310 determines whether or not the second communication is established. The processing proceeds to step S307 when it is determined that the second communication is established, or returns to step S301 when it is determined that the second communication is not established. The processing of this step corresponds to step S213.

In step S307, the controller 310 starts an operation to transmit display information for a live-view display to the smartphone 100 using the second communication, based on an image to be obtained by imaging by the imaging unit 341. The processing of this step corresponds to step S214.

In step S308, the controller 310 determines whether or not an operation signal, such as settings of photography conditions or instructions for photography have been received via the first communication. The processing proceeds to step S309 when it is determined that the operation signal has been received, or proceeds to step S310 when it is determined that the operation signal has not been received. The processing of this step corresponds to step S215 and step S220.

In step S309, the controller 310 performs processing based on the operation signal received in step S308. For example, when the controller 310 receives instructions for settings of photography conditions, it sets the photography conditions of the lens-type camera 300. When the controller 310 receives the instructions for photography, it causes the imaging unit 341 to perform photographic operation.

In step S310, the controller 310 determines whether or not to perform processing to finish the cooperation between the lens-type camera 300 and the smartphone 100 based on, for example, a control signal received from the smartphone 100 via the first communication. This determination may be made based on an output of an operation unit 350 provided in the lens-type camera 300. The processing proceeds to step S311 when it is determined that the cooperation should be finished, or returns to step S307 when it is determined that the cooperation should not be finished. The processing of this step corresponds to step S223.

In step S311, the controller 310 finishes the operation of a second communication unit 322 provided in the lens-type camera 300 and turns off the power source of the lens-type camera 300.

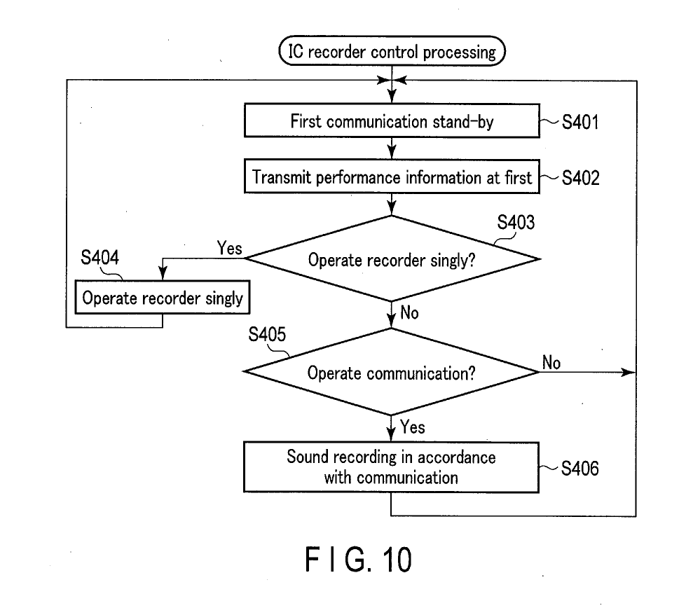

An example of an IC recorder control processing executed by the IC recorder 200 according to the second embodiment is shown as a flowchart in FIG. 10. Hereinafter, referring to FIG. 10, an explanation of the operation of the control system 1 according to the present embodiment will be continued using an example in a case where the IC recorder 200 is further used in cooperation with the smartphone 100.

In step S401, the controller 210 causes the IC recorder 200 in a stand-by state until it has received the first communication transmitted from the smartphone 100. The processing proceeds to step S402 when it has received the first communication from the smartphone 100. The operation of this step may be performed also when performance information is not requested.

In step S402, the controller 210 determines whether or not the performance information is requested by the first communication transmitted from the smartphone 100. When the controller 210 determines that the performance information is requested, the controller 210 reads the performance information of itself from a performance information storage unit 231 and transmits it to the smartphone 100 via the first communication. When it is determined that the performance information is not requested, the processing is not performed. The operation of this step corresponds to step S217.

In step S403, the controller 210 determines whether or not to cause the IC recorder 200 to operate alone based on, for example, an output of an operation unit 250 in accordance with a user's operation. The processing proceeds to step S404 when it is determined that the IC recorder 200 is caused to operate alone, or proceeds to step S405 when it is determined that the IC recorder 200 is not caused to operate alone. In step S404, the controller 210 causes the IC recorder 200 to operate alone based on, for example, an output of the operation unit 250 in accordance with a user's operation. After completion of the operation, the processing returns to step S401. The processing of this step may be finished when the first communication is received.

In step S405, the controller 210 determines whether or not a control signal to turn on the power source via the first communication has been received from the smartphone 100. The processing proceeds to step S406 when it is determined that it has received the control signal, or returns to step S401 when it is determined that the control signal has not been received. The operation of this step corresponds to step S218.

In step S406, the controller 210 turns on the power source of the IC recorder 200 based on a control signal for turning on the power source to start, for example, an operation to establish a second communication. The controller 210 sets sound collecting conditions of the IC recorder 200 based on an operation signal received by the first communication from the smartphone 100, for example. The controller 210 starts a sound collecting operation when it has received a control signal for instructing sound collecting after establishment of the second communication and continues the operation until it receives a control signal to finish sound collecting. Afterwards, the controller 210 finishes the second communication and turns off the power source of the IC recorder 200 when it has received a control signal to finish the cooperation between the IC recorder 200 and the smartphone 100, for example. Thereafter, the processing returns to step S401. The processing of this step corresponds to steps S218 to S223.

In the present embodiment, explanations have been provided using an example of a case where a recommended external device is determined based on a user having operated the camera up to its telescopic end, and the state of acquisition of audio data, however; the embodiment is not limited thereto. For example, a camera capable of determining a subject of interest and taking an image with a composition suitable for the subject of interest may be recommended, or a camera having a high-sensitivity property (common sensitivity) when it is determined as a dark scene may be recommended. In a scene determined that difference in contrast is intense, for example, in shooting a video of a night scene, a camera having a dynamic range suitable for the video shooting scene may be recommended. Furthermore, in a scene determined as including a high-frequency photographic subject, for example, in video shooting of a landscape, a camera provided with an image sensor having the number of pixels and a pixel pitch suitable for the video shooting scene, a camera provided with a lens having MTF properties suitable for the video shooting scene, etc. may be recommended. In this way, the control apparatus according to the present embodiment can recommend an external device in accordance with a scene, a status, an operation, etc.

The control system 1 according to the present embodiment has the following advantages in addition to the advantages obtained in the first embodiment. The control system 1 according to the present embodiment determines a scene, a photographic object, a sound volume, or an operation based on a user's operation history information obtained by the smartphone 100, and determines whether or not the performance of each of the built-in functions of the smartphone 100 is a performance sufficient to execute a function selected by the user. Therefore, the user can execute a selected function using an external device having a more appropriate performance by using the control system 1 according to the present embodiment.

Herein, although it is described as a function, there are various functions in a mobile device and an information processing apparatus such as smartphone, and the technique according to the present embodiment can extend each function thereof. Herein, what has been explained with a particular focus is the information obtaining function. Even in a function for obtaining information, even for a performance, there are simply various types of performance. It is necessary to determine which element of these performances can be extended. Namely, wavelength characteristics, sensitivity, directivity, a S/N ratio, a gain, a sampling frequency of A/D conversion, resolution or dynamic range of the A/D conversion, frequency characteristics, a frame rate, a recording method, temperature/humidity characteristics, a battery performance, an energy-saving performance, etc. can be enumerated as candidates of extendible elements. The control system 1 according to the present embodiment performs the cooperation of this function-extendible communication in accordance with a scene, state, or operation.

In performances of functions in the types of camera, limitations on characteristics of built-in functions, such as a diaphragm, a shutter speed, sensitivity, a focal distance, an angle of view, a focusing function, and a response, can be improved. The control system 1 according to the present embodiment can use any one of these performances or can use two or more of them in combination. With this configuration, various required performances can be determined. In information playback systems, it is advisable to organize fidelity such as color reproducibility, built-in function performances or external function performances related to a gain, S/N ratio, brightness, or frequency properties etc. and record information thereof in a database so that these performances are comparable.

### <Modifications>

An example of a case where the control system 1 includes an information communication device, such as the smartphone 100, has been explained, however; the embodiment is not limited thereto. The control system 1 may include an electronic device capable of executing one or more built-in functions and communication functions, for example, a tablet PC, camera, etc., instead of the smartphone 100. In the present embodiment, the smartphone 100 and the IC recorder 200 or the lens-type camera 300 communicate with one another, however; this communication form may be wired or wireless, or may be a communication that is performed via a communication line such as the Internet. Therefore, the external devices may be included in an IoT device. It should be noted, however, in a case where a communication is performed via a communication line such as the Internet, the smartphone 100, IC recorder 200, and lens-type camera 300 may be configured to respectively include a GPS sensor and enable obtaining positioning information of each of the devices itself by obtaining its GPS positioning value, etc.

A recommendation of an external device when the user selects the video mode is explained above, however; the embodiment is not limited thereto. For example, when the user selects a function of music playback in the smartphone 100, a speaker, etc. which is present outside the smartphone 100 may be recommended, or for example, when the user selects a function of video playback, a device having a screen display function, such as a TV and a display for PC may be recommended, or for example, when the user executes a video playback function, a device having a voice outputting function, such as a speaker, may be recommended together with a device having a screen display function such as a TV may be recommended.

Information to be recorded in the performance-specific external device DB 131 may be recorded, for example, by performing preliminary registration, etc., or may be obtained and recorded, for example, when information related to an external device, such as the IC recorder 200 or lens-type camera 300, is not recorded in the performance-specific external device DB 131. It should be noted, however; that a case where information related to an external device is not recorded in the performance-specific external device DB 131 includes, for example, a case where the external device is connected to the smartphone 100 for the first time. Furthermore, when a built-in function of the smartphone 100 is selected, whether or not there is an external device capable of executing a similar function to the selected built-in function may be determined by search via the first communication.

Even when a cooperative external device is not found in a user's surroundings, for example, when information related to the external device is recorded in the performance-specific external device DB 131, and the performance of the external device executable by the external device is higher than the performance of the built-in function executed by the smartphone 100, the controller 110 may display a recommendation, such as notifying the user that if the device is present, it is advisable to use it.

The external device may be, for example, a TV, PC display, speaker, PC, smartphone, etc. If a camera is used instead of the smartphone 100, for example, an interexchange lens, electronic flash, etc. may be included in external devices. Furthermore, this technique may be applied to a treatment tool like an endoscope, and an external device usable for a user may be recommended. An explanation placing great importance on an angle of photography is made in the first and second embodiments, however; the embodiment of the present invention is not limited thereto. As convenient searching for and communication with a peripheral apparatus is useful and is in high demand, this technique is widely applicable not only to consumer products, but also to devices for industrial products, for observation in medical and bioengineering fields, and in diagnostic devices, as long as the devices performs cooperation of a function-enhancing communication.

An example of a case where when an operation related to a function selected by a user is executed by a recommended external device, the smartphone 100 obtains data obtained by the external device via the second communication is explained above, however; the embodiment is not limited thereto. For example, based on outputs of the clock 170 provided in the smartphone 100, the clock 270 provided in the IC recorder 200, and an output of the lens-type camera 300 etc., data obtained by each of the devices may be synchronized so that thereafter the data can be recorded in association with one another. The synchronization between data may be performed by transmitting a synchronization signal to the smartphone 100 via the first communication, for example, when the external device starts obtaining data.

It is explained above that a determination related to selection of an external device, and finishing of cooperation is made based on an output of the operation unit 150 provided in the smartphone 100, however; the embodiments are not limited thereto. The determination may be made based on, for example, an output of the operation unit 250 provided in the IC recorder 200, or the operation unit 350 provided in the lens-type camera 300. The determination may be made when a communication between the smartphone 100 and the external device is discontinued.

It is explained above that the smartphone 100, the IC recorder 200, or the lens-type camera 300 may be mounted via, for example, the adopter 190, however; the embodiments are not limited thereto. Such an external device may be used by gripping by a user or may be used in a state of being attached to a thing other than the smartphone 100.

The order of each processing shown in the flowcharts, and each step in each processing may be changed, and the processing and steps may be added or deleted. Each processing is carried out by a program stored in the recording unit 130, recording unit 230, or recording unit 330, etc. Each program may be internally recorded in the smartphone 100, the IC recorder 200, or the lens-type camera 300 in advance, or may be externally recorded in a separate recording medium. The programs can be recorded in the smartphone 100, the IC recorder 200, the lens-type camera 300, or the separate recording medium in various ways. They may be recorded at the time of shipping a product, they can be recorded using a distributed recording medium, or they can be downloaded using a communication network, such as the Internet. Not only from the viewpoint of programs, a determination using artificial intelligence (AI) is available, and AI can continuously learn what kind of equipment is frequently selected and used in what kind of scene through determining a user's behavior, or can learn a behavior pattern of a third party in advance, so that search and recommendation of a related device becomes more widely applicable in various fields. Not only AI, but also a neural network using DSP, etc. may be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### <Additional Notes>

The above embodiments and modifications encompass the following control apparatuses:

[1] A control apparatus comprising:

a built-in function execution unit configured to execute a predetermined function;

a recording unit in which an external device including an external function execution unit configured to execute a function identical to the built-in function execution unit is recorded; and

a performance obtaining unit that obtains, as an external function performance, a performance of the external function execution unit from the recording unit;

a determination unit that obtains, as a built-in function performance, a performance of the built-in function execution unit to determine which performance of the built-in function performance and the external function performance is higher;

a recommendation controller that recommends use of the external device if the external function performance is higher than the built-in function performance when the built-in function execution unit executes the function; and

a communication unit that when use of the external device is selected, communicates with the external device to transmit and receive information related to an operation of the external function execution unit.

[2] The control apparatus according to [1], wherein the performance obtaining unit obtains an external function performance via the communication and records the external function performance in the recording unit.

What is claimed is:

1. A control apparatus comprising:
a built-in function execution unit configured to execute a predetermined function;
a communication unit that communicates with an external device including an external function execution unit configured to execute a function identical to the function of the built-in function execution unit; and
at least one control circuit that
obtains, as a built-in function performance, a performance of the built-in function execution unit,
obtains, as an external function performance, a performance of the external function execution unit via the communication,
determines which performance of the built-in function performance and the external function performance is higher for a comparable predetermined function,
refers to a result of the determination according to a situation of execution of a function when the built-in function execution unit executes the function, and
recommends use of the external device, when the external function performance is higher than the built-in function performance.

2. The control apparatus according to claim 1, wherein the at least one control circuit
obtains a requirement related to a performance,
determines whether the external function performance satisfies the requirement, and
recommends use of the external device when the external function performance satisfies the requirement.

3. The control apparatus according to claim 2, wherein the at least one control circuit
further determines whether the built-in function performance satisfies the requirement, and
recommends use of the external device when the built-in function performance does not satisfy the requirement and the external function performance satisfies the requirement.

4. The control apparatus according to claim 2, wherein the at least one control circuit
identifies a property requested as the requirement, and
determines that the external function performance satisfies the requirement when the external function performance is higher than the built-in function performance for the requested property.

5. The control apparatus according to claim 4,
further comprising an operation unit for operating an operation of the built-in function execution unit,
wherein the at least one control unit identifies the requested property based on a history of operations to the operation unit.

6. The control apparatus according to claim 2, wherein the at least one control circuit
identifies, as a performance requirement, a degree of the performance requested as the requirement, and
determines that the external function performance satisfies the requirement when the external function performance is higher than the performance requirement.

7. The control apparatus according to claim 6, wherein the at least one control circuit
further determines whether or not the built-in function performance is lower than the performance requirement, and
recommends use of the external device when the built-in function performance is lower than the performance requirement and the external function performance is higher than the performance requirement.

8. The control apparatus according to claim 1, wherein the at least one control circuit
obtains information on whether or not the external device is in an available state via the communication, and
recommends use of the external device when the external device is in the available state.

9. The control apparatus according to claim 1, wherein at least one control circuit
obtains information on whether or not the external device is in an available state via the communication, and
recommends preparation of the external device when the external device is not in the available state.

10. The control apparatus according to claim 1, wherein the communication unit
communicates with the external device when use of the external device recommended by the at least one control circuit is selected, and
transmits and receives information related to an operation of the external function execution unit.

11. The control apparatus according to claim 1, wherein the communication unit comprises a first communication unit and a second communication unit, the first communication unit performing a first communication including a communication to search the external device, and the second communication unit performing a second communication including a communication including data obtained by the external device, and the second communication having a higher speed than the first communication.

12. A control system comprising:
the control apparatus according to claim 1, and
the external device.

13. A control method comprising:
executing a predetermined function;
communicating with an external device including an external function execution unit configured to execute a function identical to the function;
obtaining, as a built-in function performance, a performance of the function;
obtaining, as an external function performance, a performance of the external function execution unit via the communication;
determining which performance of the built-in function performance and the external function performance is higher for a comparable predetermined function;
referring to a result of the determination according to a situation where the function is executed during execution of the function; and
recommending use of the external device when the external function performance is higher than the built-in function performance.
